(19) United States
(12) Patent Application Publication
(10) Pub. No.: US 2008/0192364 A1
(43) Pub. Date: Aug. 14, 2008

(54) Illuminated Magnifying Glass Having a Sensor Device for Switching on the Lighting Element

(75) Inventor: Alfred Schuttinger, Heroldsbach (DE)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: A. Schweizer GMBH Optische Fabrik, Forchheim (DE)

(21) Appl. No.: 11/661,710

(22) PCT Filed: Aug. 23, 2005
(86) PCT No.: PCT/DE2005/001482

§ 371 Date: Jan. 29, 2008

(51) Int. Cl. G02B 25/02

(52) U.S. Cl. 359/802

(57) ABSTRACT

The invention relates to a magnifying optical device in the form of an illuminated magnifing glass which comprises at least one handle element and one lighting device for lighting the object to be examined and a sensor device. The sensor device provided for switching on the lighting element is directed towards a support supporting the illuminated magnifying glass.

The invention/innovation relates to a magnifying optical device in the form of an illuminated magnifier, which has at least one handle element and one illuminating device for illuminating the object to be viewed and which is provided with a sensor device.

Such an illuminated magnifier emerges from DE 102 38 389 A1. The illuminated magnifier according to this state of the art involves a Visolette magnifier which can be placed directly on a document. This known illuminated magnifier has a grip element in the form of a pot-shaped edge for the magnifier body, with which the magnifier body can be pushed over the document to be viewed. In addition, a sensor that is used for switching on an illuminating device already emerges fiom the known Offenlegungsschrift. In the state of the art, the sensor reacts to the hand of the user. For this purpose, it is arranged in the side area of the handle.

The invention/innovation is supported on the task of constructing a magnifying optical device with the features of the preamble of claim 1 such that it is improved in terms of its switch-on device. This task is achieved in that the sensor device provided for switching on the illuminating element is directed towards a support carrying the illuminated magnifier. For this purpose, a sensor element of the sensor device can be directed towards the support, wherein the sensor device is constructed, e.g., as a push switch, and the sensor element is constructed as an element acting mechanically on the support. It is especially advantageous for the sensor device to be constructed as an optical sensor that interacts with the support, because then the sensor can react, e.g., to changes in brightness or contrast in the area of the support. Such an optical sensor can be arranged in a recess that is open towards the support or behind a window or a filter disk facing towards the support, and can have a light-emitting and a light-sensitive area. In an especially advantageous way, the sensor element is arranged on or in the lower end of a mounting foot that forms a support area for the illuminated magnifier, with the mounting foot being arranged on the side of the handle element facing away fiom the magnifier body.

In an improvement or alternative construction of the invention, the sensor can be a sensor analyzing the color of the document to be viewed with the illuminated magnifier, with the illuminating device being designed for the emission of different colors and being controllable by the sensor in terms of its color emission. Such an illuminated magnifier selects the color of the illumination as a function of the color composition, in particular, of a mean color composition and brightness, so that an optimum, i.e., contrast-promoting illumination in the appropriate spectral range is guaranteed for a visually impaired person. In addition, it is also conceivable to control the brightness automatically as a function of the brightness of the document.

Such a sensor can be designed as a color camera. Such color cameras are available today as miniature components, so that the precise construction of the sensor does not need to be discussed in more detail. Such a color camera delivers an output signal that can be fed to a color analyzing unit whose output signal controls a color control circuit of the illuminating device. In combination with such a color-analyzing sensor device, an illuminating device is offered that is constructed as an LED or LED group that is variable in terms of its color.

The invention is explained in more detail with reference to embodiments in the drawing figures. Shown are:

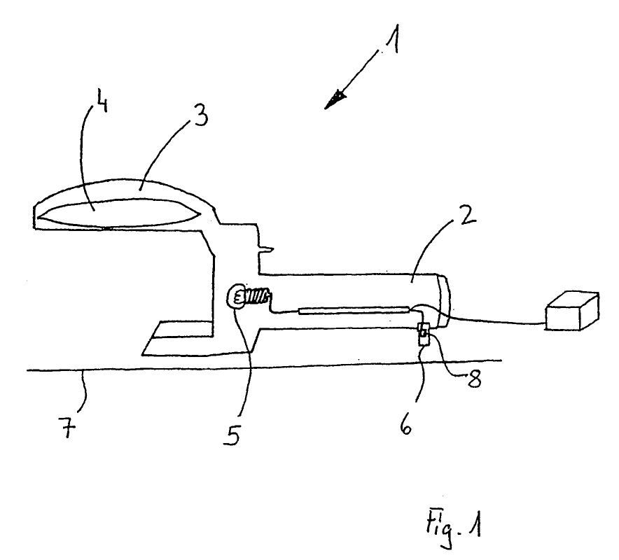

FIG. 1, a section through the illuminated magnifier with a sensor element;

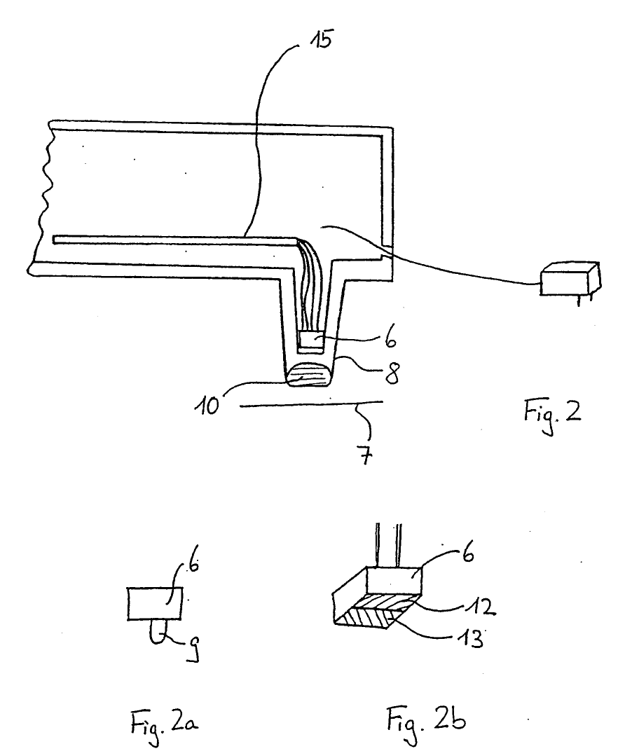

FIG. 2, the arrangement of the sensor element in the mounting foot;

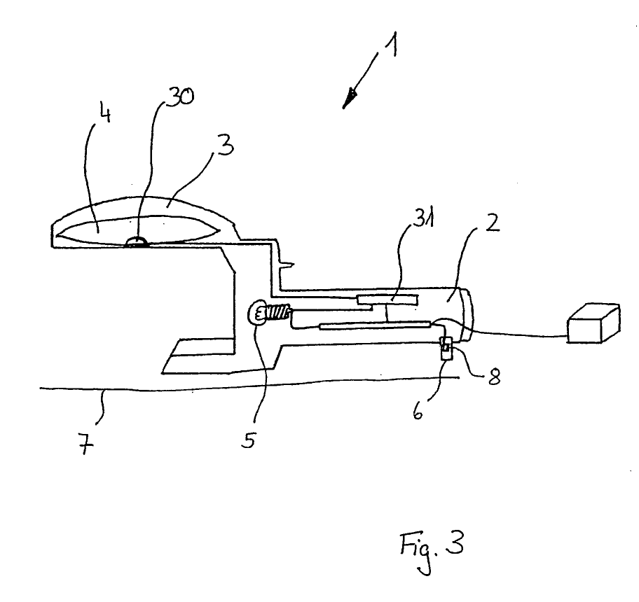

FIG. 3, another schematic representation according to FIG. 1, in which another or alternative sensor is provided that can analyze the color(s) of the document to be viewed with the illuminated magnifier.

At first reference is made to drawing FIG. 1. The magnifying optical device has the form of an illuminated magnifier 1, which has a handle element 2, a magnifier body 4 arranged in a frame 3, and also an illuminating element 5. In addition, there is at least one sensor device 6, which is used for switching on the illuminating element 5. The sensor device 6 is provided in an area 8 supporting the illuminated magnifier 1 against a support 7, e.g., a document to be viewed or a table-like base. Here, a sensor element 9 of the sensor device 6 is directed towards the support 7.

With reference to FIG. 2, the sensor device 6 can be constructed as a push switch, with reference being made to FIG. 2A. Then a sensor element 9 of the sensor device 6 projects from a cutout 10 of the area 8 acting on the support. In contrast, if the sensor device is constructed as an optical sensor, then the recess 10 can be closed with a window. An optical sensor device, which is suitable for mounting in an area 8 supporting the illuminated magnifier against the support, is shown in FIG. 2B and has a light-emitting area 12 and a light-sensitive area 13. If such a sensor is moved over a patterned support, then the reflection characteristics change and a signal coming from the light-sensitive area can be processed in a sensor circuit on a circuit board 15 of the sensor device 6 and used for switching on and off the illumination.

With reference to FIG. 3, the magnifying optical device can have a sensor 30 that is suitable for analyzing the color or color composition of the support 7 to be viewed with the illuminated magnifier 1, with the illuminating device 50 being designed for the emission of different colors and being controllable by the sensor 30 in terms of its color emission. For this purpose, the sensor 30 is constructed as a small color camera whose output signal is fed to a color analyzing unit 31 in terms of the detected colors. The output signal ofthis color analyzing unit controls a color control circuit of the illuminating device.

It should be noted that the entire electronic [system] of the color analysis sensor 30 could be switched on by means of the sensor device 6 for a combination arrangement of a sensor 6 and a color analysis sensor 30. The arrangement of a color analysis sensor with a light source that can be controlled in terms of its colors is especially suitable when the magnifying optical device is used in connection with a color camera by means of which a visually impaired person can view the material to be read via a television monitor. Then especially good contrast properties are provided.

It should be noted that the color control device does not necessarily have to convert the light source in terms of its color emission to red, blue, or green light or the like, but instead, through the combination of light sources of different colors or color-shifting light-emitting diodes, only small color shifts towards the red or blue range can be sufficient to improve the contrast properties. In addition, the brightness of the color emission can naturally also be adapted to the support.

1-17. (canceled)

18. A magnifying optical device in the form of an illuminated magnifier that has at least one handle and one illuminating device for illuminating the object to be viewed and which is provided with a sensor device, wherein the sensor device provided for switching on the illuminating element is directed towards a support supporting the illuminated magnifier.

19. The optical device of claim 18, wherein the sensor device is arranged in an area directed downwards and supporting the illuminated magnifier against the support.

20. The optical device of claim 18, wherein the sensor device is constructed as a push switch and a sensor element is constructed as an element acting mechanically on the support.

21. The optical device of claim 19, wherein the sensor device is constructed as a push switch and a sensor element is constructed as an element acting mechanically on the support.

22. The optical device of claim 18, wherein the sensor device is arranged in a recess that is open towards the support in the area supporting the illuminated magnifier against the support.

23. The optical device of claim 18, wherein the sensor device is constructed as an optical sensor.

24. The optical device of claim 23, wherein the sensor device is arranged behind a window or a filter panel.

25. The optical device of claim 23, wherein the sensor device has an area emitting radiation and an area that reacts to this radiation.

26. The optical device of claim 24, wherein the sensor device has an area emitting radiation and an area that reacts to this radiation.

27. The optical device of claim 18, wherein the sensor element is arranged in the bottom end of a mounting foot that forms a supporting area of the illuminated magnifier.

28. The optical device of claim 18, wherein the magnifier a rechargeable power source and a circuit board of the sensor device are arranged in the handle element.

29. The optical device of claim 18, wherein a rechargeable power source and a circuit board of the sensor device are arranged in the handle element.

30. The optical device of claim 18, wherein the magnifier body of the illuminated magnifier is held by a fork-like mounting foot parallel to and at a distance from the support to be viewed, and the illuminating element is arranged in the area between the magnifier body and the mounting foot.

31. The optical device of claim 18, wherein the illuminating element is arranged in the area of the fork-like foot and is used for illuminating the support with glancing light.

32. The optical device of claim 31, wherein glancing illumination of the support can be generated by the illuminating element.

33. The optical device of claim 18, wherein the sensor device has an electromechanical sensor, which has a ball that can roll on the support and that interacts with a sensor element acting on the ball surface.

34. A magnifying optical device in the form of an illuminated magnifier that has at least one illuminating element and one sensor, wherein the sensor is a sensor analyzing at least a color of the support to be viewed with the illuminated magnifier and the illuminating device is designed for the emission of different colors and can be controlled in terms of its color emission by the sensor.

35. The optical device of claim 34, wherein the sensor is constructed as a color camera and the output signal can be fed to a color analyzing unit in terms of the detected colors, and the output signal of this color analyzing unit controls a color control circuit of the illuminating device.

36. The optical device of claim 34, wherein the illuminating device is constructed as an LED or LED group(s) that is variable in terms of its color.

37. The optical device of claim 35, wherein the illuminating device is constructed as an LED or LED group(s) that is variable in terms of its color.
